(19) United States
(12) Patent Application Publication
(10) Pub. No.: US 2008/0176019 A1
(43) Pub. Date: Jul. 24, 2008

(54) Carpet

(76) Inventor: Kristen Bragdon, Chattanooga, TN (US)

Correspondence Address: KILYK & BOWERSOX, P.L.L.C., 400 HOLIDAY COURT, SUITE 102, WARRENTON, VA, 20186, US

(21) Appl. No.: 11/811,400

(22) Filed: Jun. 8, 2007

Related U.S. Application Data
(60) Provisional application No. 60/812,392, filed on Jun. 9, 2006.

(51) Int. Cl. B32B 5/08

(52) U.S. Cl. 428/44; 428/89

(57) ABSTRACT

A carpet is described which incorporates a set of distinct figures, shapes, or patterns. In embodiments as described, each of the set of shapes can begin in one color pattern and end in another color pattern, for instance, changing from a set of darker colors or tones to a lighter set of colors or tones. An adjacent set of shapes then begins in the same color pattern in which the preceding shapes end, and extends to another color pattern in which that adjacent set of shapes terminate. The blending effect of the color patterns preserves a visually continuous appearance, even when contrasting sets of shapes are placed side by side. In embodiments, carpet tiles cut from the carpet incorporating the multiple shapes and color patterns as described herein can be assembled into a tiled flooring assembly, while also maintaining a consistent visual appearance. Other aspects of the present invention are also described.

This application claims the benefit under 35 U.S.C. §119(e) of prior U.S. Provisional Patent Application No. 60/812,392, filed Jun. 9, 2006, which is incorporated in its entirety by reference herein.

### BACKGROUND OF THE PRESENT INVENTION

The present invention relates to carpet, and more particularly relates to carpet containing a set of dissimilar patterns and colors which can be combined in a single installation while maintaining a consistent or pleasing visual effect.

In the commercial carpet market, certain customers and applications may require carpet containing a set of diverse patterns or shapes along with a variety of colors. Applications can include broadloom carpet installations where an entirely uniform or repetitive effect is not desired, for instance, due to architectural or design considerations. In certain other applications, the technique of installing a carpet surface using a side by side combination of comparatively small squares or tiles has been developed. However, in either broadloom carpet or carpet tile applications, the combination of a diverse set of figures, patterns or colors in the textile face of the carpet can result in a visually incongruous effect. This clashing effect can result, for example, from dissimilar patterns or shapes being placed side by side, or in the case of tiled applications, from the juxtaposition of tiles having different patterns, shapes, or colors directly next to each other in conflicting orientations.

Nevertheless, the carpet market still demands products and installations with multiple shapes or patterns, and/or installations in which a tiled installation is desired without relying on rigid tile arrangements that can require added workman time and cost, and that sacrifice a visually diverse effect. Accordingly, there is a need in the textile industry to develop carpet designs and constructions and tile installation techniques that can incorporate multiple or diverse shapes, patterns, and colors, while maintaining a consistent or harmonious visual effect.

### SUMMARY OF THE PRESENT INVENTION

A feature of the present invention is to provide a carpet having a pattern or design incorporating a diverse set of patterns, figures or shapes along with a variety of color regions, patterns or combinations, while maintaining a consistent visual effect.

A further feature of the present invention is to provide a carpet having a pattern or design incorporating a set of diverse shapes, figures, or patterns, along with a variety of colors, which can be used to create tiles that can be installed together side by side in a random or other orientation, while still maintaining a consistent visual effect.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

To achieve these and other advantages, and in accordance with the purposes of the present invention, as embodied and broadly described herein, the present invention relates to a carpet having a series of shapes, figures, or patterns formed therein. In one or more embodiments, the set of shapes can comprise first shapes, second shapes adjacent to the first shapes, third shapes adjacent to the second shapes, and fourth shapes adjacent to the third shapes, for example in a banded configuration or sequential configuration. According to various embodiments, the first shapes can be constructed in a first color pattern transitioning to a second color pattern, while the second shapes can be constructed beginning in the second color pattern and transitioning to a third color pattern. Similarly, the third shapes can be constructed beginning in the third color pattern and transitioning to a fourth color pattern, while the fourth shapes can be constructed beginning in the fourth color pattern and transitioning to a fifth color pattern. According to various embodiments, one or more additional shapes, figures, or patterns can also be incorporated. According to various embodiments, each adjacent set of shapes is preferably distinct or different from an adjacent set of shapes. According to various embodiments, while the sets of shapes embedded or constructed in the carpet are visually distinct, a coherent or continuous visual effect is achieved due, in one regard, to the continuity or blending effect between color regions.

The present invention further relates to a series of carpet tiles formed from the carpet having a series of shapes constructed in color regions or color patterns as described above.

The present invention also relates to a method to form a carpet having a visually consistent or continuous appearance incorporating different patterns, figures, or shapes in different color patterns as described above.

It is to be understood that both the foregoing general description and the following detailed description are exemplary and explanatory only and are intended to provide a further explanation of the present invention as claimed.

The accompanying drawings, which are incorporated and constitute a part of the present application, show aspects of the present invention and together with the description serve to explain one or more principles of the present invention.

### BRIEF DESCRIPTION OF THE DRAWINGS

FIG. 1 is a drawing of a carpet constructed according to at least one embodiment of the present invention, including a series of shapes, figures, or patterns arranged adjacent to each other in coordinated color regions.

FIG. 2 is a drawing of a carpet tile according to at least one embodiment of the present invention, incorporating diverse shapes, figures, or patterns in different color regions or patterns constructed in a substrate.

FIG. 3 is a drawing showing a carpet installation assembled from a set of carpet tiles each incorporating a set of shapes, figures, or patterns in different color regions or patterns.

FIG. 4 is a drawing showing an overall carpet pattern, according to at least one embodiment of the invention.

### DETAILED DESCRIPTION OF THE PRESENT INVENTION

The present invention relates to a carpet that incorporates a set or series of diverse shapes, figures, and/or patterns in a set of color regions or color patterns that can be installed in broadloom or tiled form, while maintaining a visually coherent or consistent appearance. According to at least one embodiment of the present invention, different shapes, figures, and/or patterns each having or being formed in one or more associated color region or color pattern can be combined in a single installation. According to embodiments of the present invention, a diverse set of shapes, figures, patterns and color patterns can therefore be incorporated in a broadloom, carpet tile, or tile assembly without causing a visually incongruous or clashing effect.

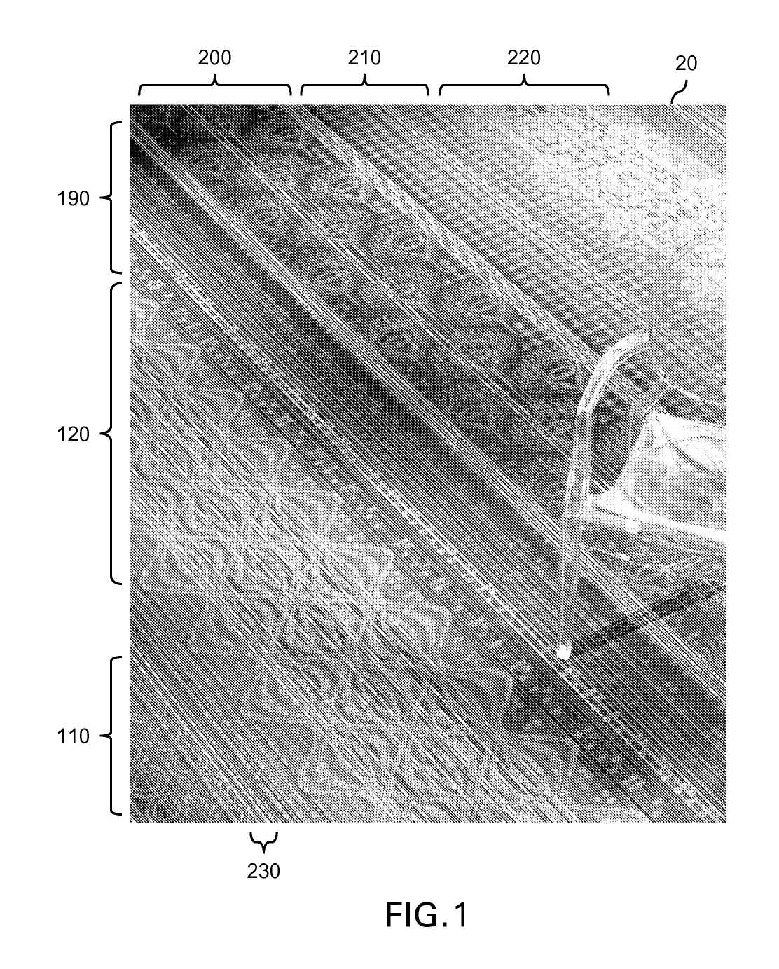

In more detail, and as for example illustrated in FIG. 1, according to at least one embodiment, the present invention relates to a carpet 20 incorporating a set or series of distinct shapes, figures or patterns in the textile face or nap of carpet 20. As illustrated in FIG. 1, the shapes, figures, or patterns can include, for instance, a set of circle shapes 110, generally illustrated as a pair of concentric circles arranged side by side. Other arrangements of circles can be used. As illustrated, the carpet 20 can also incorporate a set of oscillatory shapes 120, generally illustrated as a set of nested periodic, sinusoidal or other wave-like shapes. Other arrangements of oscillatory shapes can be used. The shapes in carpet 20 as illustrated can further include a set of dotted shapes 190, generally illustrated as a set of dotted or hashed shapes arranged in small clusters. Other arrangements of dotted shapes can be used. The carpet 20 as illustrated can further incorporate a set of curved shapes 200, generally illustrated as a set of tail-feather or other curved or fan-like shapes. Other arrangements of curved shapes can be used. The carpet 20, as illustrated, can likewise include or incorporate a set of checked shapes 210, generally illustrated as a hound's-tooth pattern or arrangement. Other arrangements of checked shapes can be used. The carpet 20 can, as illustrated, also include a set of floral shapes 220, generally illustrated as a repeated floral or lace-like pattern. Other arrangements of floral patterns can be used. For purposes of the present invention, any shape can be used and the present invention is not limited to the particular shapes identified herein. For instance, one or more of the shapes can be any geometric shape having or defined by straight lines or edges and/or defined by or having curve lines or boundaries, such as triangles, squares, rectangles, multi-sided objects, half moons, animal shapes, any cylindrical shapes, oval shapes, and the like. Any shape can be used for each of the sets of shapes used herein. It is also possible to use more than one shape per set of shapes in the pattern. Thus, for instance, the “first shapes” can be or constitute one shape or two or more different shapes, which can be intermixed, overlap each other (e.g., partially) or follow each other sequentially or be in any other arrangement. This is also true for all sets of shapes (e.g., “second shapes,” “third shapes,” etc.)

It will be appreciated that although FIG. 1 shows in one regard an illustrative set of six distinct shapes or design patterns embedded in recurring color patterns, other numbers or sizes of shapes, figures, or patterns, other types of shapes, figures, or patterns, and/or other sequences, repetitions or arrangements of shapes, figures, or patterns can be used. For instance, less than or more than six shapes can be used in the design, such as two, three, four, five, six, seven, eight, nine, ten, or more shapes can be used. For example, according to at least one embodiment, a carpet 20 incorporating the set of six distinct shapes, figures, or patterns as illustrated can include a set of those same six shapes in a different, alternating, randomized, or otherwise rearranged order or other arrangement. According to at least one embodiment, the set of shapes can for example be configured in a diagonal or other orientation to a machine direction or cross-direction of the carpet 20, to edges of the carpet 20 or tiles thereof, or in other configurations. According to further embodiments, more than one shape can be combined, alternated, or overlain with another shape in a pattern area, if desired. According to yet further embodiments, the length or width of each of the various sets of shapes can be the same, or can be different. Thus, for example, a carpet 20 which can form a 12′ broadloom can have each of the six illustrated sets of shapes having a width of 2 feet, but any of the sets of shapes can have any other desired width. As another example, one set of shapes (e.g., first shapes) can be 2 feet wide in pattern and the second shapes can be 3 feet wide in pattern. Any combination of pattern can be achieved. Similarly, the dimensions of individual design elements in each of the sets of shapes, such as circles, floral figures or others, can be any desired size.

As illustrated in FIG. 1, according to at least one embodiment, the carpet 20 can also incorporate a set of one or more linear elements 230. The set of linear elements 230 can include one or more comparatively narrow stripes or lines which can be interspersed through or between one or more of the other embedded shapes, figures, or patterns. According to one or more embodiments, any one or more of the set of circle shapes 110, oscillatory shapes 120, dotted shapes 190, curved shapes 200, checked shapes 210, and floral shapes 220 (or other shapes) can be provided in a machine direction or cross-direction of carpet 20. According to at least one embodiment, the set of linear elements 230 can be provided in a machine direction or cross-direction of the carpet 20. According to at least one embodiment, all of one distinct group, band or set of shapes in a machine direction or cross-direction of the carpet 20 can be the same, or repeat in a regular pattern. According to further embodiments, the set of shapes encountered along a strip or section in a machine direction or cross-direction of the carpet 20 can be different. According to at least one embodiment, the colors in one distinct color pattern extending in a machine direction or cross-direction of the carpet 20 can be the same, or repeat in a regular pattern. According to at least one embodiment, the color patterns encountered along a strip or section in a machine direction or cross-direction of the carpet 20 can be different. According to at least one embodiment, the length, width, or number of repetitions of any of the set of shapes or color patterns can be varied, and need not be equal to each other. According to at least one embodiment, the carpet 20 along with the embedded sets of shapes can be produced using known broadloom production techniques, including, for instance, tufting or stitching a substrate with fibers in a linear direction.

For purposes of the present invention, the carpet 20 of the present invention can be in any form or shape. For instance, the carpet can be or form a carpet tile of any dimensions as described elsewhere herein, 6 ft. wide, 12 ft. wide, broadloom carpet, woven carpet, wall to wall and the like. Essentially, any type of carpet can be formed. The carpet 20 can also be considered or can comprise a textile substrate. Also the yarn or other material used to form the carpet 20 can be considered textile fibers. In embodiments, the yarn or textile fibers can define a fibrous face or nap, a primary backing to which the textile fibers are secured, and a secondary backing secured to the primary backing. For purposes of the present invention, the term “textile substrate” relates to, but is not limited to, a fiber, web, yarn, thread, sliver, woven fabric, knitted fabric, non-woven fabric, upholstery fabric, tufted carpet, and piled carpet formed, from natural and/or synthetic fibers. The yarn or fibers can be natural or synthetic, can be any length and have any size, and can be any brand or type used to form carpets.

According to at least one embodiment of the present invention, in one regard, a set of shapes such as those described above, or others, can be constructed in a set of defined color patterns formed in the carpet 20. A set of shapes in a section of the carpet 20 can begin with a first color pattern and extend to and terminate in another or ending color pattern, while maintaining the same shape, figure, or design. According to at least one embodiment, the color patterns can for example be defined by runs of colored fiber in a machine direction or cross-direction of carpet 20.

According to one or more embodiments of the present invention, the color pattern in which a set of shapes terminates is the same color pattern in which an adjacent set of shapes begins. Due, in part, to the dovetailing effect of the color patterns across carpet 20, wherein borders or seams between different sets of shapes are deemphasized due to color patterns which overlap shapes, a continuity of visual effect or impression is maintained even while the shapes, figures or patterns constructed in a section of carpet 20 change.

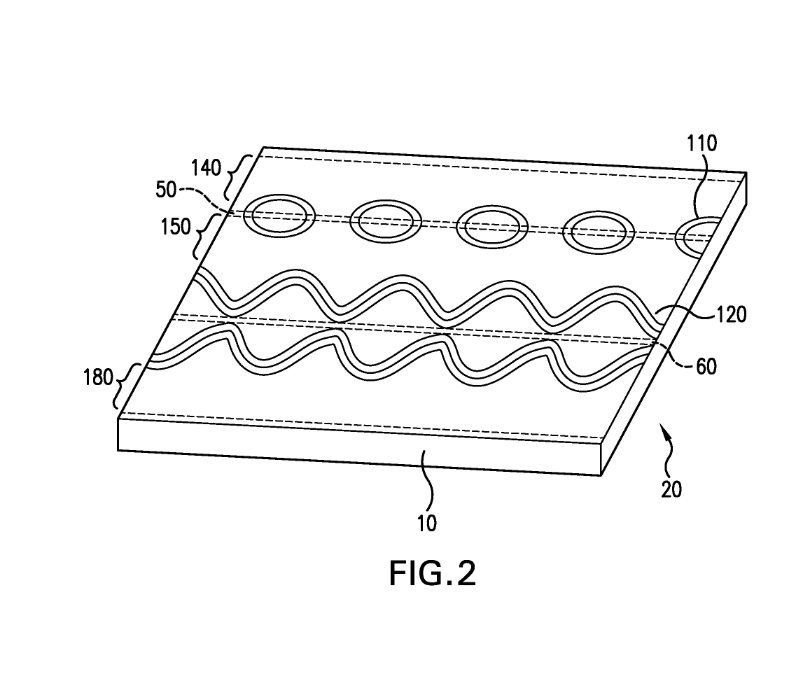

Thus, and as, for example, illustrated in FIG. 2, according to embodiments, a pattern such as a set of circular shapes 110 can be provided next to a set of oscillatory shapes 120 in a carpet 20 having a substrate 10. According to embodiments as shown, the set of circular shapes 110 can begin in a first color pattern 140. The first color pattern 140 can include, for example, one or more of white, yellow, gold, or other colors, hues, or tones, or combination of the same. For example, the colors of the first color pattern 140 and other color patterns described herein can be formed by the dyed or otherwise colored fiber or material of carpet 20. According to embodiments, that colored material can be tufted, stitched, or otherwise embedded in substrate 10. According to embodiments, the colors of a color pattern can be configured in a speckled or stippled pattern, or in other configurations.

According to at least one embodiment of the present invention, the first color pattern 140 can transition across the set of circular shapes 110 to a second color pattern 150. According to various embodiments, the second color pattern 150 can include, merely for example, one or more colors such as turquoise, medium green, dark or forest green, or other colors, hues, or tones, or combinations of the same. According to various embodiments, the transition from the range of colors present in the first color pattern 140 to the colors present in the second color pattern 150 can be gradual, for example, by altering the tufted fiber content, exposed length, or density between the first color pattern 140 and the second color pattern 150. According to embodiments, a transition zone 50 can be interposed between the first color pattern 140 and second color pattern 150. Transition zone 50 can contain, for example, intermediate color gradations between the first color pattern 140 and the second color pattern 150. While transition zone 50 is illustrated as being of comparatively narrow width compared to the first color pattern 140 and second color pattern 150, the transition zone 50 can be any width, for example, the same or comparable width as the first color pattern 140 and the second color pattern 150, or have a larger width. According to further embodiments, the first color pattern 140 can be arranged beside the second color pattern 150 without a transition zone 50 or intermediate or other color gradations. Other transitions or relationships between color patterns can be used.

For purposes of the present invention, any number of transition zones can exist between the first color pattern and the second color pattern, and this is also true for the remaining color patterns. In other words, any number of transition zones can occur between the second color pattern and the third color pattern, and so on. In at least one embodiment of the present invention, the first color pattern will have at least one color that is the same or present in the second color pattern. For instance, at least one color, two colors, three colors, or four colors can be the same in the first color pattern and in the second color pattern. The one or more same colors does not necessarily have to be in the same location. For instance, one color in the first color pattern can define (or partly define) a first shape, and the same color can be present in the second color pattern to also define a shape and/or may be used to serve as a type of background color. In at least one embodiment of the present invention, at least one color is the same in the first color region and the second color region and so on. In other words, at least one color will be the same in the second color region compared to the third color region, and at least one color will be the same in the third color region compared to the fourth color region, and so on. The color that is the same from region to region does not necessarily have to be the same. In other words, the same color that may exist in the first color region and the second color region may or may not be the same or similar color between the second color region and the third color region and so on. Further, for purposes of the present invention, it is to be understood that the reference to color pattern (throughout the present invention) means that the color pattern is defined by at least one color and, generally, more than one color, such as at least two colors, at least three colors, at least four colors, at least five colors, at least six colors, or more. Generally, the shapes referenced herein can be defined by at least one color, at least two colors, at least three colors, at least four colors, and so on. With respect to the transition zone, which may or may not exist, again, the transition zone can have at least one color that is the same as the color patterns located on each side of the transition zone. For purposes of the present invention, the transition zone or zones can have at least one color, at least two colors, at least three colors, at least four colors, at least five colors, and so on, that are the same as the color regions located on each side of the transition zone or zones.

Also, in the same embodiment or different embodiments, the first color pattern and the second color pattern can have at least one color that is different. In other words, at least one color present in the one color region (e.g., first color region) will not be present in the adjacent color region (e.g., second color region). The number of different colors existing between regions can be at least one color that is different, at least two colors that are different, at least three colors that are different, at least four colors that are different, at least five colors that are different, and so on. The reference to color is generally with respect to the color of yarns that are visually seen on top of the textile face. As is known to those skilled in the art, when a yarn(s) are not visible on top of the carpet, the yarn is tufted tight against the substrate. For purposes of the present invention, it is to be understood that patterns are created by tufting tight yarn that does not form the visual pattern and not tufting tight other yarn that forms the visual pattern. One skilled in the art will understand the tufting bar and tufting needle settings used to achieve these patterns upon reading the present invention. As stated, there can be more than one transition zone between each color pattern, such as two transition zones, three transition zones, four transition zones, and so on. As stated above, in the same embodiment or a different embodiment, the transition zone or zones can have at least one color that is different from one or both of the color patterns that the transition zone is located between. For instance, the transition zone or zones can have at least one color, at least two colors, at least three colors, at least four colors, at least five colors, or at least six colors, or more, that are different from one or both regions that are located on either side of the transition zone.

According to at least one embodiment, and as also shown in FIG. 2, the set of oscillatory shapes 120 that is next or adjacent to the set of circular shapes 110 can begin in the second color region 150. The portions of the set of oscillatory shapes 120 located in the second color pattern 150 therefore share the same set of colors as the set of circular shapes 110 which end in the second color pattern 150. In various embodiments as shown, the set of oscillatory shapes 120 that begin in the second color pattern 150 terminate in a third color pattern 180. The third color pattern 180 can include, merely for example, a set of medium blue, deep blue, or other colors, hues, or tones, or combinations of the same. According to embodiments, a transition zone 60 can be interposed between the second color pattern 150 and third color pattern 180. Transition zone 60 can contain, for example, color gradations between the second color pattern 150 and the third color pattern 180. While transition zone 60 is illustrated as being of comparatively narrow width compared to the second color pattern 150 and third color pattern 180, according to embodiments the transition zone 60 can be any width, for example, the same or comparable width as the second color pattern 150 and the third color pattern 180. According to further embodiments, the second color pattern 150 can be arranged beside the third color pattern 180 without a transition zone 60 or intermediate or other color gradations. Other combinations of sets of shapes, color patterns, and constituent colors can be used. It may be noted that according to various embodiments, the length and width of each of the first color pattern 140, second color pattern 150, transition zone 50, transition zone 60 and any other color patterns or areas can be the same, can be different, or can in general be any desired length and width.

According to at least one embodiment, carpet 20 may comprise a broadloom carpet which can be installed over a flooring surface to effectively cover a desired area. According to one or more embodiments, including embodiments illustrated in FIGS. 1 and 2, the carpet 20 may comprise, form, or be cut into a carpet tile, such as a square 18″ by 18″ or other sizes. According to various embodiments, a set of carpet tiles fabricated in this fashion can be assembled or installed side by side to form a floor covering. When carpet tiles cut or fabricated according to one or more embodiments of the present invention are combined to provide a modular flooring installation, it may be noted that it is not necessary to arrange the individual carpet tiles in a specific orientation to achieve a visually consistent effect. According to various embodiments, it is instead possible to arrange the carpet tiles in an irregular or random orientation, while still preserving the continuity of the visual impression. Installation time and workman training can therefore be reduced. According to various embodiments, floor coverings may also be installed as a combination of broadloom carpet and carpet tiles, as desired. Also, solid color tiles or other carpet tile designs can be randomly or non-randomly placed amongst the carpet tiles of the present invention.

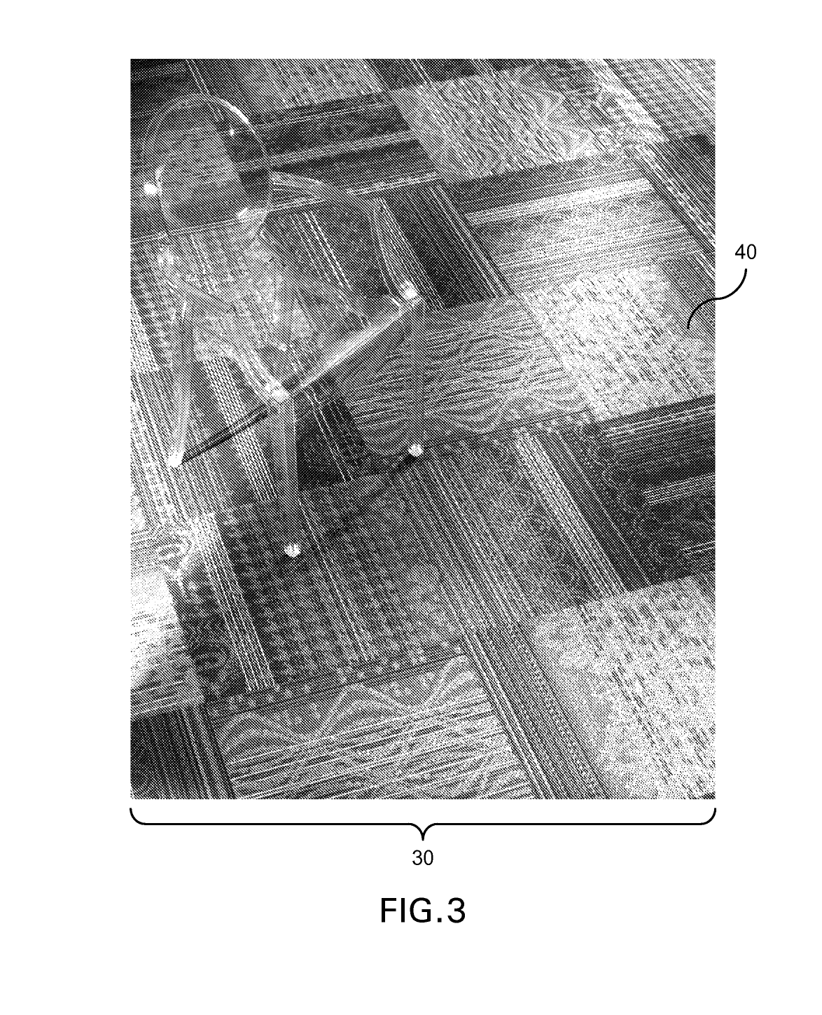

FIG. 3 illustrates a set of individual carpet tiles 40 arranged in a tiled installation 30. According to one or more embodiments as shown, a set of linear elements 230 in individual carpet tiles 40 may be arranged with linear elements running in a parallel or perpendicular orientation to adjacent carpet tiles. The linear elements (e.g., lines) can be straight, curves, or have both characteristics. The linear elements can have any color(s). It may be noted and as illustrated in FIG. 3, while a diverse visual appearance is created, the orientation of individual carpet tiles 40 can be readily observed. Again, the carpet tiles 40 of the modular or tiled installation 30 can however be installed in an irregular or randomized pattern without detracting from the visual effect. A tiled installation 30 can also make repair of the floored surface more convenient since, among other things, one or a small number of carpet tiles 40 that have been damaged or soiled can be individually replaced.

In one or more embodiments, the present invention relates to a carpet tile having a textile face and having a pattern on the textile face. The pattern can comprise first shapes in a first color pattern and ending in a second color pattern, which is different from the first color pattern, and second shapes in a second color pattern and adjacent to said first shapes and, optionally, ending in a third color pattern, which is different from the second color pattern. Each individual carpet tile can generally have at least two sets of shapes present on each individual carpet tile and each individual carpet tile can have at least two color patterns present on the carpet tile though, for purposes of the present invention, each individual carpet tile can have two or more sets of shapes as defined herein and each carpet tile can have two or more color patterns as defined herein. In addition, each individual carpet tile or at least some of the carpet tile can have transition zone(s) located between the color patterns as defined herein.

When modular carpet tiles 40 are assembled using the present invention in a tiled installation 30, the carpet tiles 40 can be a ¼-turn modular installation, ½-turn modular installation, or any other form of standard installation used for carpet tiles. For instance, the carpet tiles 40 can be assembled in a ⅓-⅔ pattern or in a ⅓-⅓-⅓ pattern. Other possible configurations using different types or arrangements of carpet tiles 40 can be used to present a unique appearance of tiled installation 30. For example, a shuffled configuration using the same carpet tiles 40 but turning the carpet tiles 40 in different or randomized directions can be used. Another configuration, referred to as a brick configuration, can be used in which the carpet tiles 40 can be used but shifted in different sections of tiled installation 30. Needless to say, any type of configuration using the various carpet tiles 40 can be used to create a variety of appearances. In embodiments, a tiled installation 30 may be installed using carpet tiles 40 having no linear elements, or different sets of patterns, figures, shapes, linear elements, or other visual elements than those shown. Although generally illustrated in a square shape, carpet tiles 40 can be formed or cut in other shapes, such as rectangles, diamonds, and other shapes. Furthermore, while the carpet tiles 40 illustrated in the tiled installation 30 of FIG. 3 are shown as being the same size, carpet tiles 40 of different shapes or sizes can be assembled together.

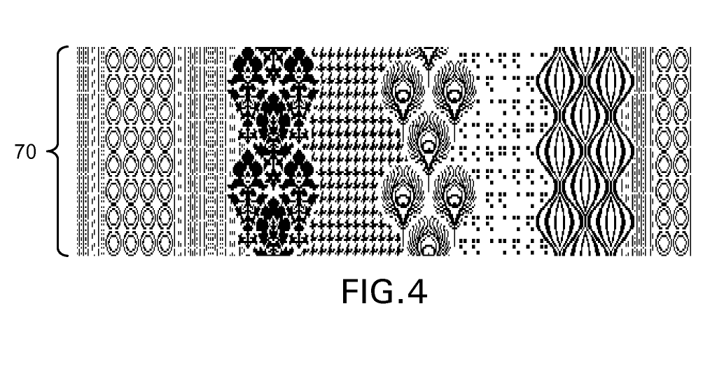

According to one or more embodiments of the present invention, and as shown in FIG. 4, the set of shapes to be used in a carpet 20 can be represented, stored, or encoded in an overall carpet pattern 70 specifying shapes, colors, dimensions, and other parameters. According to embodiments in one regard, the color pattern 70 can be stored in machine-readable format to, for instance, program a computer-controlled machine to produce carpet 20. Thus, the present invention provides a carpet design incorporating a set of diverse shapes, figures, or designs imparting a unique visual impression while maintaining a consistent visual effect. The present invention similarly allows a designer or installer to specify an installation of carpet 20 in any desired orientation, including a random orientation, promoting freedom of configuration and ease of installation. According to embodiments, the repetitive effect of conventional carpet tiling is reduced or eliminated.

Below is one embodiment of the present invention. Being constructed of 8 colors—5 colors in the background, 2 of which are accent colors, and 3 colors in the foreground or overlay with a 6′ thread up repeat in the background, a 2′ thread up repeat in the foreground or overlay, and a 12′ pattern repeat in the foreground or overly.

The combination thread up of the background and foreground or overlay creates a 12′ thread up repeat due to the colors and color combinations being out of sync from the background and the foreground or overly. The groupings of color combinations are as follows:

1. A, C, D, F, G, H

2. A, D, G, H

3. A, D, E, G, H

4. A, B, E, H

5. A, B, D, G

6. B, F

7. A, B, F, G, H

8. B, C, D, F, G

9. B, C, D, E

10. A, C, E, F, G, H

The background thread up is as follows: 5.875″ of alternating, gradating colors of C and A, 2.5″ of color A, 2.5″ of alternating, gradating colors A, G, and H with G and H being accent colors interspersed with color A, 2.5″ of color A, 11.75″ of alternating, gradating colors of A and B with accent colors G and H interspersed, 4.25′ of color B, 12.875″ of alternating, gradating colors B and C with accent colors G and H interspersed, 4.25″ of color B, 11.75″ of alternating, gradating colors of B and C with accent colors G and H interspersed, 2.5″ of color C, 2.5″ of alternating colors C and accent colors G and H, 2.5″ of color C, and 6″ of alternating, gradating colors A and C with accent colors G and H interspersed for a total of 72″. This is then repeated for a total thread up width of 144″.

The foreground or overlay thread up is as follows: 6″ of alternating, gradating colors of D and F, 12″ of color D, 12″ of alternating, gradating colors of D and E, 23″ of color E, 13″ of color F, 6″ of alternating, gradating colors D and F, 6″ of alternating, gradating colors of D and E, 16.75″ of color E, 12″ of alternating, gradating colors of E and F, 7.25″ of color F, and 6″ of alternating, gradating colors of D and F for a total thread up of 12′. For purposes of the present invention, less or more colors can be used or other color combinations can be used.

Applicant specifically incorporates the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range or preferred value and any lower range limit or preferred value, regardless of whether ranges are specifically disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the specification and examples be considered as exemplary only, with a true scope and spirit of the present invention being indicated by the following claims and equivalents thereof.

What is claimed is:

1. A carpet having a textile face and having a pattern on said textile face, wherein said pattern comprises:
first shapes in a first color pattern and ending in a second color pattern which is different from said first color pattern;
second shapes in said second color pattern and adjacent to said first shapes, and ending in a third color pattern which is different from said second color pattern;
third shapes in said third color pattern and adjacent to said second shapes, and ending in a fourth color pattern which is different from said third color pattern; and
fourth shapes in said fourth color pattern and adjacent to said third shapes, and ending in a fifth color pattern which is different from said fourth color pattern.

2. The carpet of claim 1, further comprising at least one additional shape distinct from the first shape, the second shape, the third shape, and the fourth shape.

3. The carpet of claim 1, wherein the first, second, third, and fourth shapes repeat in a machine direction of the carpet.

4. The carpet of claim 1, wherein the first, second, third, and fourth shapes are different in a cross direction to a machine direction of the carpet.

5. The carpet of claim 1, wherein at least one of the shapes is a curved shape, an oscillating shape, a dotted shape, a floral shape, a checked shape, a hound's-tooth shape, or a circle shape.

6. The carpet of claim 1, further comprising at least one linear element interposed through at least one of the shapes.

7. The carpet of claim 1, wherein the carpet is a tile.

8. The carpet of claim 1, wherein the carpet is cut into carpet tiles.

9. A floor covering comprising a plurality of the carpet tiles of claim 8 positioned side by side.

10. The floor covering of claim 9, wherein the tiles are assembled in a random orientation.

11. The carpet of claim 8, wherein the carpet tiles are square.

12. The carpet of claim 1, wherein the color patterns in a machine direction of the carpet repeat.

13. The carpet of claim 1, wherein the color patterns in a cross direction to a machine direction of the carpet are different.

14. The carpet of claim 1, wherein at least two of the color patterns are equal in width.

15. The carpet of claim 1, wherein the colors of the color patterns are determined by the color of fibers exposed on top of said textile face.

16. The carpet of claim 1, wherein the transition between the beginning and end colors of the color patterns is graduated.

17. The carpet of claim 1, wherein the shapes are parallel to an edge of the carpet.

18. The carpet of claim 1, wherein at least two of the shapes are parallel to each other.

19. The carpet of claim 1, wherein the carpet has a background color.

20. A carpet tile having a textile face and having a pattern on said textile face, where said pattern comprises:
first shapes in a first color pattern and ending in a second color pattern which is different from said first color pattern; and
second shapes in said second color pattern and adjacent to said first shapes, and optionally ending in a third color pattern which is different from said second color pattern.
